(19) United States
(12) Patent Application Publication
(10) Pub. No.: US 2007/0170389 A1
(43) Pub. Date: Jul. 26, 2007

(54) Valve structure and valve device having same field of the invention

(76) Inventor: Kazuo Koizumi, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/654,623

(22) Filed: Jan. 18, 2007

(30) Foreign Application Priority Data
Jan. 24, 2006 (JP) 015598/2006

(51) Int. Cl. F16K 1/36

(52) U.S. Cl. 251/205; 251/335.3

(57) ABSTRACT

A tubular part 4 capable of slidably fitting inside a valve hole 1 is formed on a valve disc surface 3a, which is a plane on the side of the surface of a valve disc 3, which constitutes a valve structure, to be in close contact with a valve seat 2. When the valve disc 3 is in the closed position, the whole tubular part 4 is within the valve hole. A clearance in the fitting between the tubular part 4 and the valve hole 1 can substantially shut off the flow of a fluid A1. The tubular part 4 has an opening in a tip end face 4a; a through-hole 5 is formed in the outer circumferential surface of the body thereof: and when the valve disc is moved from the closed position to the open position, the through-hole of the tubular part 4 enters the valve chest, whereby the valve hole communicates with the valve chest through the tubular part via the through-hole. As a result, the fluid does not directly hit the valve disc surface in the open position, and the deposition of substances on the valve disc surface can be suppressed.

### FIELD OF THE INVENTION

The present invention relates to a valve structure to allow passage or shutting off of a fluid and a valve device internally containing the structure.

### BACKGROUND OF THE INVENTION

A bellows valve is one example of the valve devices used for passing-shutting or opening-closing of a high-pressure fluid and a fluid that needs to be shut off from the outside, as well as formation of vacuum and the like (e.g., Japanese Unexamined Patent Publication No. 10-504375, JP-A-2005-155677).

FIG. 6 schematically shows the manner of open-close of the valve structure in a conventional bellows valve, wherein the inner wall surface of a valve chest (chamber) V10 has an open valve hole 100 to be the inlet of a fluid from the outside, and the periphery of the open mouth in the inner wall surface provides a valve seat 120.

A valve disc 130 performs a reciprocating movement of contacting closely to and disengaging from the valve seat 120, thereby opening or closing the valve hole. In this way, the open-close action of a valve device is performed.

While a gasket, an O-ring and the like are set on the valve seat surface 120 or on a valve disc surface (surface of valve disc to be in close contact with the valve seat) 130a to enhance the sealability upon closing of the valve, they are not shown.

In FIG. 6(a), the valve disc 130 is in the closed position to shut off the flow between the valve hole 100 and another fluid passage 150 open into the valve chest. In FIG. 6(b), the valve disc 130 is in the open position, and a fluid A10 in an internal space V20 of the valve hole can flow through the valve chest V10 to the fluid passage 150.

An operating shaft S10 for the reciprocating movement of the valve disc is connected to a back face 130b of the valve disc 130, where the shaft penetrates the wall of the valve chest and is connected to a driving mechanism located outside the valve chest. In addition, a bellows 140 is set to surround the operating shaft S10. One end face of the bellows 140 is bonded (normally welded) to the back face 130b of the valve disc 130, and the other end face of the bellows 140 is bonded to the inner wall surface of the valve chest. Consequently, the bellows 140 follows the reciprocating movement of the valve disc 130 while expanding and/or contracting, prevents leakage from the penetration site of the operating shaft S10 through the wall, separates a space V30 on the driving mechanism side from the valve chest V10, and maintains a highly closed state in the valve chest.

The valve device exemplarily shown in FIG. 6 is what is called an “L type valve”, where the valve hole 100 and the other fluid passage 150 are approximately orthogonal to each other, and open into the valve chest generally at an angle of 90°.

However, the present inventor examined the open-close state of the valve structure in the above-mentioned valve with the lapse of time, and noted the following problem.

The problem refers to a degraded shut off performance of the valve when, for example, the flow of an exhaust gas in a diffusion furnace is to be controlled using the valve shown in FIG. 6, which performance is caused by the deposition of impurities, contained in the exhaust gas, mainly on the valve disc surface (surface to be contacted to and disengaged from the valve seat surface) during repeated open-close operation of the valve disc, which deposition in turn inhibits a close contact between the valve disc and the valve seat.

Such degraded shutoff performance of the valve causes disorders in facilities using the valve, where recovery of the shutoff performance increases the maintenance costs.

The above-mentioned problem of deposition of foreign substances on the valve disc surface occurs in any open-close structure in the valve, besides the bellows valve.

The object of the present invention is to suppress at least the deposition of foreign substances on the valve disc surface.

### SUMMARY OF THE INVENTION

The present inventor has conducted intensive studies and found that a constitution wherein a tubular member is protruded from the valve disc surface into a valve hole, and a fluid is flown from a through-hole formed in the tubular member when the valve disc is in the open position, thereby altering the direction of the fluid flow, can preferably suppress the deposition of the substance on the valve disc surface, which resulted in the completion of the present invention.

Accordingly, the present invention is characterized by the following.
(1) A valve structure comprising at least a valve hole open in an inner wall surface of a valve chest, a valve seat surrounding the opening, and a valve disc that comes into a close contact with or disengages from the valve seat to open-close the aforementioned valve hole, wherein

the valve disc surface, which is a plane on the side of the whole surface of the valve disc to be in close contact with the valve seat, has a protruding tubular part capable of slidably fitting inside the valve hole,

when the valve disc is in the closed position, the entire tubular part is within the valve hole, a clearance in the fitting between the tubular part and the valve hole is capable of substantially shutting off the flow of a fluid passing through the valve hole, the tubular part having an opening in a tip end face, the tubular part having a through-hole in the circumferential surface of its body, and the through-hole being formed at such a position that a part or the whole of the through-hole enter the valve chest when the valve disc is in the open position, and

when the valve disc is moved from the closed position to the open position, the through-hole formed in the tubular part enters the valve chest from the inside of the valve hole, thereby communicating the valve hole and the valve chest through the inside of the tubular part.
(2) The valve structure of (1), wherein the whole length of the tubular part is so determined as to place the tip of the tubular part within the valve hole even when the valve disc is in the open position.
(3) The valve structure of (1), wherein the position and size of the through-hole are so determined as to place the whole through-hole within the valve chest when the valve disc is in the open position.
(4) The valve structure of (1), wherein the valve hole has a circular cross sectional shape, and the tubular part as a cylindrical shape.
(5) The valve structure of (1), further comprising, besides the valve hole, a fluid passage, communicating with the outside, in the inner wall surface of the valve chest,

the central axis of the valve hole being substantially orthogonal to that of the fluid passage,

the number of the through-hole to be formed in the tubular part being one, and

the through-hole facing toward the fluid passage opening and the central axis of the hole being parallel to that of the fluid passage.
(6) A valve device comprising the valve structure of any one of the above-mentioned (1) to (5).
(7) The valve device of (6), further comprising an operating shaft to open-close the valve disc in the valve structure from the outside of the valve chest, the shaft being inserted from the outside into the valve chest, and the tip of the shaft being connected to the valve disc.
(8) The valve device of (6), which is a bellows valve wherein the outer circumference of the body of the operating shaft is covered with a bellows.
(9) The valve device of (6), which is an L type valve, further comprising, besides the valve hole, a fluid passage opening, communicating with the outside, in the inner wall surface of the valve chest, wherein the central axis of the valve hole is substantially orthogonal to that of the fluid passage.
(10) The valve device of (9), wherein the central axis of the valve hole is substantially orthogonal to that of the fluid passage,

the number of the through-hole to be formed in the tubular part is one, and

the through-hole faces the fluid passage opening and the central axis of the hole is substantially parallel to that of the fluid passage.

### BRIEF DESCRIPTION OF THE DRAWINGS

FIG. 1 is a sectional view schematically showing the constitution and action of the valve structure of the present invention. In FIG. 1(a), the valve disc is in the closed position, in FIG. 1(b), the valve disc is in the open position, and a fluid in the valve hole can communicate from the inside of the tubular part through the through-hole into the valve chest.

FIG. 2 shows an example of the shape of an opening of the through-hole to be formed in the tubular part.

FIG. 3 is a sectional view showing an example of the position of the through-hole to be formed in the tubular part.

FIG. 4 is a sectional view schematically showing the structure of a bellows valve, which is one of the preferable embodiments of the valve device.

FIG. 5 is a sectional view more specifically showing the structure of a bellows valve, which is one example of the valve device.

FIG. 6 is a sectional view schematically showing the structure of a conventional bellows valve.

The reference symbols in the Figures show the following. 1; valve hole, 2; valve seat (valve seat surface), 3; valve disc, 4; tubular part, 5; through-hole, V1; valve chest (chamber).

### DETAILED DESCRIPTION OF THE INVENTION

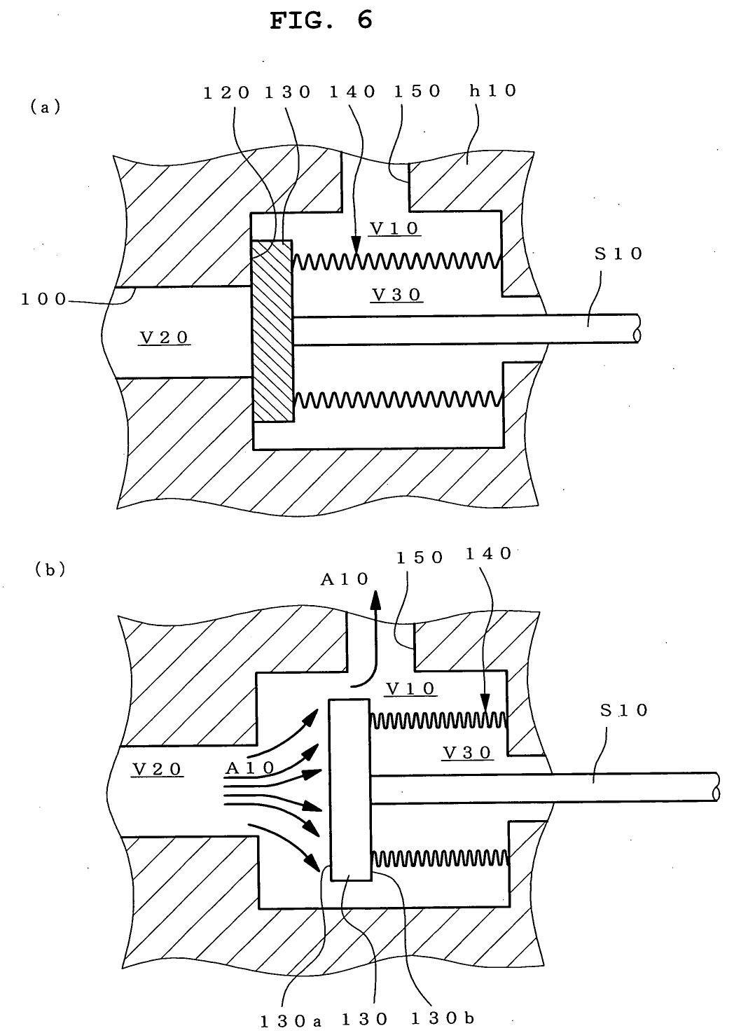

In a conventional valve structure, when a fluid blows out from the valve hole into the valve chest, fluid A10, as shown in FIG. 6(b), directly smashes into the valve disc surface 130a in the open position, and then spreads omnidirectionally into the valve chest V10. Therefore, the substances contained in the fluid (hereinafter to be referred to as contained substances) highly possibly deposit on the valve disc surface.

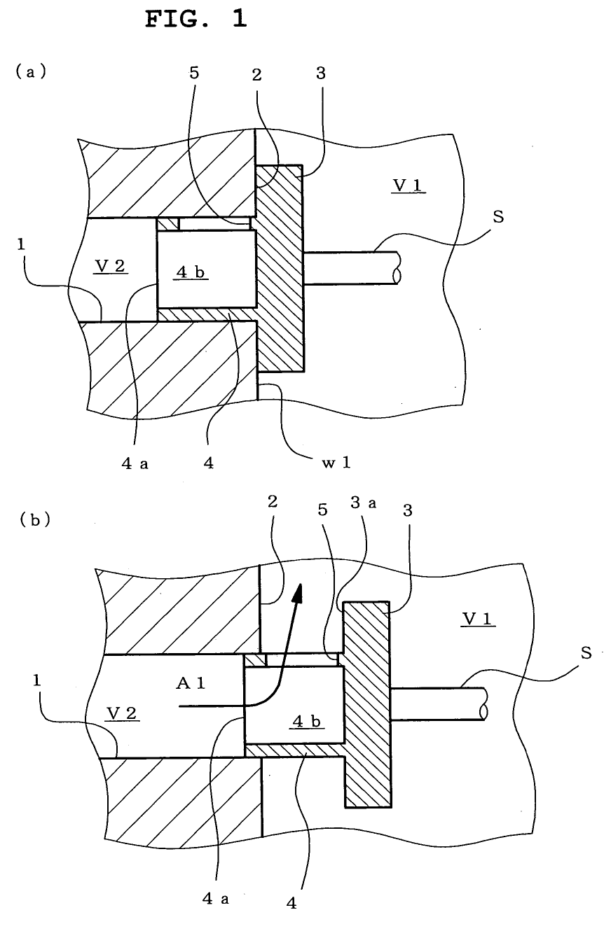

In contrast, in the valve structure of the present invention, whose closed state is shown in FIG. 1(a), a tubular part 4 protruding from a valve disc surface 3a slidably enters a valve hole 1. The tubular part 4 and the valve hole are in a fitting relation, with a clearance permitting slidability of the tubular part and less leakage of a liquid. The tubular part 4 has an open tip end face 4a, and the body thereof has a through-hole 5 on the surface of the outer circumference.

By the addition of such a tubular part, when the valve structure is open (flowing state), a fluid A1 transversely flows out from the through-hole 5 of the tubular part 4 into a wide valve chest, as shown in FIG. 1(b). Therefore, the fluid does not directly hit the valve disc surface in the perpendicular direction. As a result, the amount of deposition of the contained substance on the valve disc surface decreases.

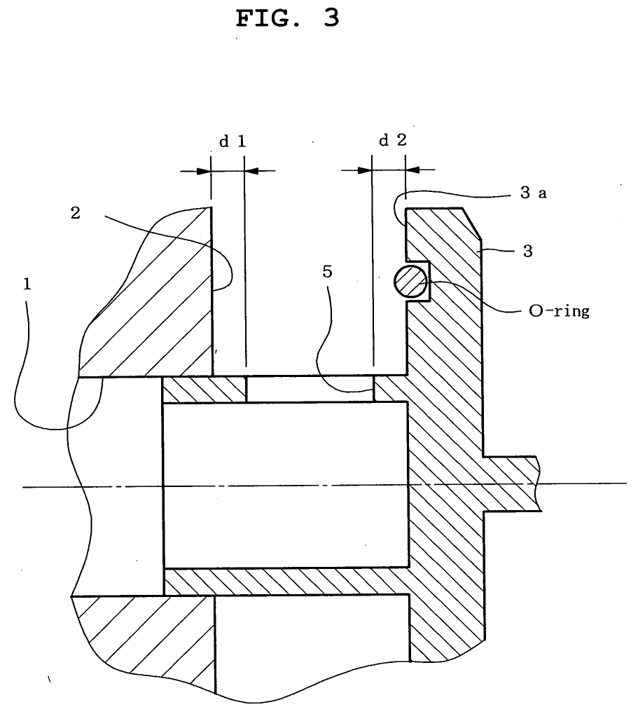

Particularly, in an L type valve, the central axes of the valve hole 1 and a fluid passage 6 on the other side are substantially orthogonal to each other, as shown in FIG. 3.

When the valve structure is to be applied to the L type valve, the fluid A1 can also be introduced into the fluid passage 6 more efficiently by setting the through-hole 5 in the tubular part 4 to face the fluid passage 6 on the other side.

The valve structure of the present invention is explained first.

As shown in FIG. 1, the valve structure of the present invention is composed of at least a valve seat 2 and a valve disc 3. The valve seat 2 is formed on the inner wall surface W1 of a valve chest V1, and the valve seat 2 has an open valve hole 1 in its central part. The valve disc 3 provides a reciprocating motion (open-close motion) of close contact with and detachment from the valve seat, thereby open-closing the valve hole 1.

As explained in the above-mentioned section of the effect, the valve disc surface 3a, which is the surface of the valve disc 3 to be in close contact with the valve seat, has a tubular part 4 as a protrusion (the central axis of the tubular part being perpendicular to the valve disc surface). As shown in FIG. 1(a), when the valve disc 3 is in the closed position, the whole length of the tubular part enter the aforementioned valve hole 1.

While the detail of the fitting relation between the tubular part and the valve hole is explained below, the clearance thereof permits sliding of the tubular part while substantially shutting off the flow of a fluid. A complete shutting off of the flow of the fluid is afforded by the close contact between the valve seat surface and the valve disc surface.

The tip end face 4a of the tubular part 4 has an opening and the inner space 4b of the tubular part communicates with the valve hole inner-space V2. In addition, the tubular part 4 has a through-hole 5 in the outer circumference of the body. The position of the through-hole 5 is so determined as to make a part or the whole of the through-hole enter the valve chest when the valve disc is in the open position (full gate opening state).

As shown in FIG. 1(b), when the valve disc is moved from the closed position to the open position, the tubular part 4 is pulled out from the valve hole into the valve chest, allowing the through-hole 5 to appear from within the valve hole into the valve chest, whereby the valve hole communicates with the valve chest via the inside of the tubular part and the through-hole. In the open position, the valve seat 2 and the valve disc surface 3a are sufficiently apart, and a fluid A1 blows out transversely (perpendicular to the central axis) from the through-hole 5 through the wide space, as a result of which the direct impact of the fluid A1 on the valve disc surface 3a can be alleviated and the amount of deposition of the contained substance can be reduced.

While the direction of the flow of a fluid is not particularly limited when the valve structure is used, when the fluid proceeds from a space V2 in the valve hole to a valve chest V1, the deposition of foreign substances on the valve seat surface, which is observed with the conventional valve structures, can be more effectively reduced, and the usefulness of the present invention becomes noticeable.

In addition, when the valve structure is applied to an L type valve, the direction of flow can be directed toward the outlet opening utilizing the through-hole in the tubular part. Thus, the usefulness of the present invention becomes more remarkable.

The cross sectional shape of the valve hole (when the valve hole is cut perpendicularly to its central axis) is not limited, and it may be a circular shape, ellipse, polygon (triangle, rectangle, polygon), an irregular shape and the like.

In consideration of the sealability of the valve hole, easiness of the hole processing, easiness of the processing of the tubular part to be fitted with the hole and the like, the cross sectional shape of the valve hole is preferably a circular shape. The shape of the tubular part is preferably rendered a cylindrical shape in accordance therewith.

An embodiment wherein the cross sectional shape of the valve hole is a circular shape and the tubular part has a cylindrical shape is explained in the following. When the cross sectional shape of the valve hole is changed, the design of other parts may be modified as appropriate.

The inner diameter of the valve hole is not particularly limited and varies depending on the flow of the fluid to be controlled and the like. In view of the applicability to valves of general use, it is preferably about 20 mm-300 mm, particularly about 25 mm-100 mm.

The length of stroke from the closed position to the open position of the valve disc may be designed to become suitable for the size of the valve hole, and the stroke length of the valve disc of general valve devices may be referred to. For example, when the valve hole has an inner diameter of 70 mm, the stroke length of the valve disc is appropriately about 30 mm-40 mm.

The material of the valve seat, the shape of the valve seat surface, the material of the valve disc, the shape of the valve disc surface, the seal structure (shape of gasket or O-ring, and mounting structure thereof) for enhancing the close shut property upon sealing of the valve seat surface and the valve disc surface and the like may be designed appropriately for the use of the valve structure and the prior art may be referred to. Both the valve seat surface and valve disc surface are depicted on a simple flat plane in FIG. 1 for the explanation's sake. However, for example, a complicated concave convex surface, a gasket or an O-ring may be employed to improve the sealability of the valve.

The outer diameter of the tubular part is determined according to the inner diameter of the valve hole.

The clearance in the fitting of the both [difference (D−d) between the inner diameter D of valve hole and outer diameter d of the tubular part] is such that permits sliding of the tubular part in the valve hole and substantially shuts off the flow of a fluid passing through the valve hole.

By the “substantially shuts off the flow of a fluid” is meant sufficiently decreasing flow of a fluid to the extent that conventional deposition of substances is prevented even when the flow of the fluid passing through the clearance directly hits the valve disc surface.

While the value of the fitting clearance is not particularly limited, too large a clearance impairs the significance of the tubular part. While a smaller clearance is more preferable, too small a clearance inhibits the slidability of the tubular part, which in turn prevents smooth reciprocating movement of the valve disc.

One preferable example of the clearance in the fitting of a tubular part and a valve hole is shown in the following.

When the inner diameter of the valve hole is 20 mm-100 mm, the clearance in the fitting is 0.1 mm-5 mm, preferably 0.5 mm-1 mm.

When the inner diameter of the valve hole is 100 mm-150 mm, the clearance in the fitting is 0.2 mm-15 mm, preferably 1 mm-3 mm.

When the inner diameter of the valve hole is 150 mm-300 mm, the clearance in the fitting is 0.4 mm-25 mm, preferably 2 mm-5 mm.

These numerical ranges are mere rough values, and may be adjusted appropriately according to the finishing of the inner surface of the valve hole, the surface of the outer circumference of the tubular part and the like. When the inner diameter of the valve hole is out of the above-mentioned ranges, the amount of the clearance in the fitting, which permits sliding of the tubular part in the valve hole, and substantially shuts off the flow of a fluid passing through the valve hole, can be determined by experiment to achieve the object of the present invention.

The whole length of the tubular part may be designed according to the stroke length of the valve disc, and the inner diameter of the valve hole. However, the whole length is preferably longer than the stroke length of the valve disc, so that the tip of the tubular part will be within the valve hole even when the valve disc is in the open position. The length of the tubular part within the valve hole in the open position is preferably about 2 mm-50 mm.

For example, when the inner diameter of the valve hole is 70 mm and the stroke of the valve disc is 30 mm, the whole length of the tubular part of about 32 mm-35 mm is suitable for practical use.

Since the whole length of the tubular part is longer than the stroke length of the valve disc, the fluid always flows from the tubular part via the through-hole into the valve chest, even when the valve disc is in the open position. Moreover, problems of “inclined improper contact” that occurs during sliding between the tubular part and the valve hole does not occur easily.

The tubular part may be integrally formed with the valve disc by casting, cutting and machining and the like. Since the thickness is rather small and the material can be freely determined exclusively for the tubular part, a tubular part is preferably formed separately and then bonded to the valve disc. The bonding method may be welding, fusion splicing, bolting, calking and the like.

While the material of the tubular part is not limited, metal materials are preferable from the aspects of corrosion resistance, heat resistance and the like. Of the metal materials, stainless is particularly preferable.

While the thickness of the tubular part varies depending on the inner diameter of the valve hole and the material of the tubular part, it is, for example, preferably about 1 mm-5 mm when the inner diameter of the valve hole is about 20 mm-300 mm and the material is stainless.

The outer circumferential surface of the body of the tubular part and the inner surface of the valve hole are preferably subjected to a smoothing treatment to reduce the resistance of sliding, such as an abrasive processing and the like. In addition, various lubricating treatments may be applied, if possible, in relation to the fluid.

The position and the shape of the through-hole to be formed in the tubular part may be any as long as a part or the whole of the opening of the through-hole enters the valve chest so that the through-hole can function as the passage of the fluid when the valve disc is in the open position.

For sufficient utilization of the thus-formed through-hole as a flow path, the entire through-hole preferably enters the valve chest when the valve disc is in the open position. For separation of the flow of a fluid, that enters the valve chest from the through-hole, from the surface of the valve seat, moreover, as shown in FIG. 3, the inner surface on the tip side of the through-hole 5 is preferably located inside the valve chest by a particular distance d1 from the valve seat surface 2. When the aforementioned particular distance d1 is to be formed, it is appropriately determined by reference to the inner diameter of the valve hole and the inner diameter of the through-hole. For general use, d1 is suitably about 2 mm-15 mm.

Similarly, for separation of the flow of a fluid, that advances from the through-hole into the valve chest, from the valve disc surface, as shown in FIG. 3, the inner surface of the base end side of the through-hole 5 is preferably away from the valve disc surface 3a toward the tip side by a particular distance d2. When the aforementioned particular distance d2 is to be formed, it is suitably about 2 mm-15 mm as in the case of the aforementioned distance d1.

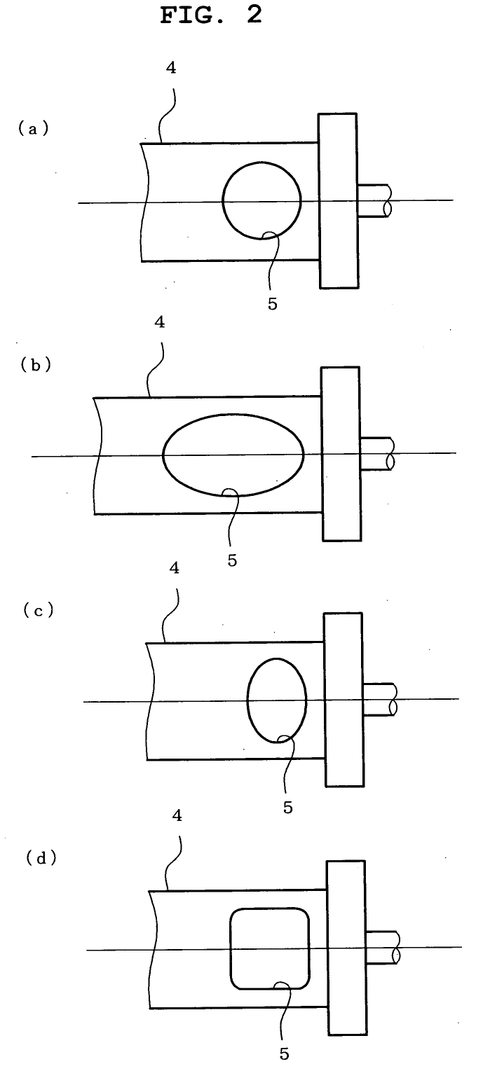

The shape of the opening of the through-hole to be formed in the tubular part (shape of the through-hole appearing in the plane view of the through-hole along the central axis of the through-hole) is not particularly limited. Since the hole forming and calculation of the flow rate are easy, and undesired turbulent in the flow can be eliminated, a circular shape as shown in FIG. 2(a), an ellipse longer in the axis direction of the tubular part as shown in FIG. 2(b), an ellipse longer in the outer circumference direction of the tubular part as shown in FIG. 2(c), a quadrate as shown in FIG. 2(d), and the like are preferable. When the tubular part is a circular cylinder, the actual shape of the opening of the through-hole is the line of intersection.

While the size (inner diameter) and number of the through-hole to be formed in the tubular part is not particularly limited, it is preferably designed to have a sufficient total opening area, so that the through-hole will not inhibit the flow when the valve disc is in the open position. For example, when the inner diameter of the valve hole is 70 mm, and the tubular part of the cylindrical shape to be inserted in the hole has one through-hole with a circular opening shape, the inner diameter is preferably about 25 mm-50 mm, particularly about 30 mm-35 mm. These ranges are mere examples, and optimal values may be selected from outside the aforementioned ranges, depending on the pressure of the fluid to be controlled.

As indicated in the explanation of the above-mentioned effect, when the valve is an L type valve shown in FIG. 3, the central axis of a valve hole 1 and the central axis of a fluid passage 6 on the other side are approximately orthogonal to each other (that is, they cross at an angle near 90°), and generally form an angle of 90°. In this case, it is preferable that the number of the through-hole in the tubular part be one, the through-hole face the inner wall surface side where the fluid passage is open, and the central axis of the through-hole be parallel to the central axis of the fluid passage, whereby the fluid is smoothly introduced toward the fluid passage on the other side by the action of the through-hole.

The valve structure of the present invention is applicable not only to an independent product of a valve device but may be directly formed in a part with which to control the flow of a fluid.

The valve device of the present invention is now explained.

The valve device is produced using the valve structure of the present invention. The constitution of other parts of the valve device may be the same as in the conventionally-known valve devices. As shown in FIG. 1, an operating shaft S is preferably inserted into the valve chest from the outside to operate the open-close motion of the valve disc from the outside of the valve chest, and the tip of the shaft is preferably connected to the back face of the valve disc 3.

The valve device may have various forms such as an L type valve (angle valve) and the like, from the positional relationship between the two ports (valve hole and the other passage) open into the valve chest.

In the case of an L type valve as mentioned above, a fluid can be smoothly introduced toward the fluid passage on the other side by the action of the through-hole formed in the valve structure of the present invention.

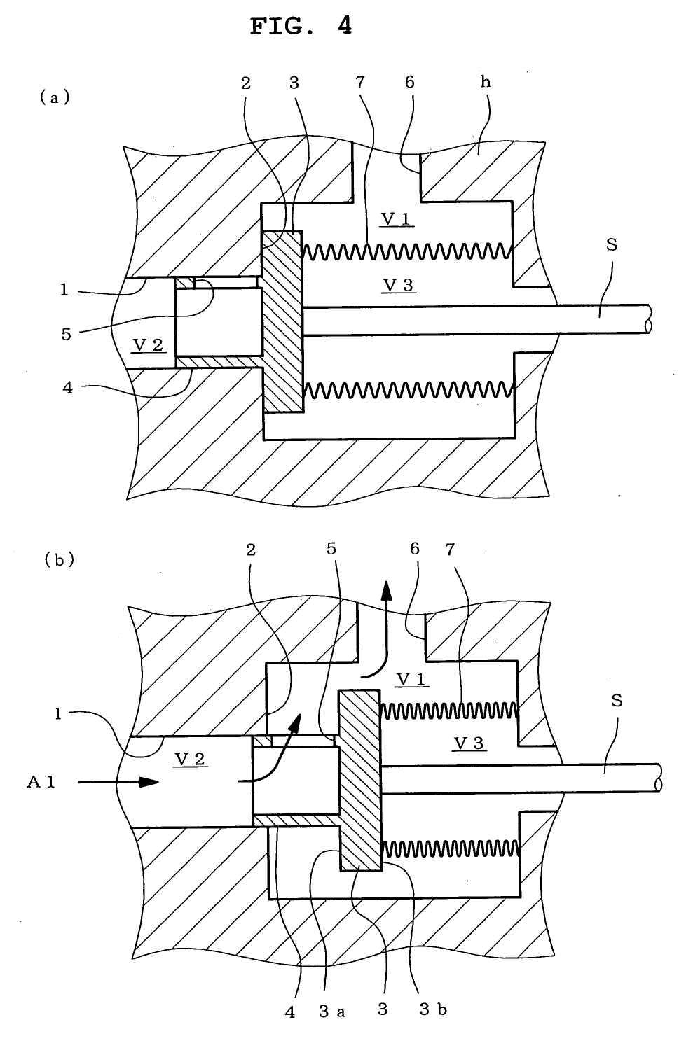

FIG. 4 is a sectional view schematically showing the structure of a bellows valve, which is one preferable example of the valve device. The valve device is an L type valve, wherein two ports open in the valve chest are substantially orthogonal to each other.

As the valve structure, the valve structure of the present invention is used and the tubular part 4 formed in the valve disc 3 enters the valve hole 1. The constitution of the bellows valve itself other than the valve structure is the same as the conventional mechanism shown in FIG. 6. To be specific, a shaft S as a mechanism for a reciprocating stroke motion of the valve disc 3 is connected to a back face 3b of the valve disc, and the shaft is connected to a reciprocating mechanism (air cylinder etc.) disposed outside the valve chest (FIG. 4). A bellows 7 is formed on the back face 3b of the valve disc 3 to air-tightly or fluid-tightly isolate a space V3 on the reciprocating mechanism side from a valve chest V1, and covers the area surrounding the shaft S. One end of the bellows 7 is connected to the back face 3b of the valve disc 3 and the other end face is bonded to an inner wall surface of the valve chest. As a result, the bellows 7 isolates the valve chest V1 from the space V3 on the reciprocating mechanism side, while stretching following the reciprocating movement of the valve disc 3 with highly tight sealability.

The material (stainless and the like) and size of conventional bellows valves may be used for the bellows here.

As a bellows for handling a high-pressure fluid or vacuum, a metal bellows obtained at an ultra fine pitch by the following production method is preferably used.

A method of producing a metal bellows tube, which comprises preparing a metal bellows fundamental tube wherein sectional shapes of a ridge and a valley in a bellows-shaped tube wall are U-shaped, compressing said fundamental tube in the longitudinal direction to bring adjacent ridges and valleys of the bellows-shaped tube wall into close contact with each other, further pressure-forming the tube until the inside space of each ridge and the gap between adjacent ridges substantially disappear by pressing, and then stretching, in the longitudinal direction of the tube, the fundamental tube after the pressure forming until a peak-to-peak gap of the adjacent ridges reaches a predetermined distance.

The mechanism to afford a reciprocating movement of the valve disc is not limited. For example, in the example shown in FIG. 4, a shaft (rod) S to reciprocate the valve disc enters the valve chest from the outside of the housing h. The other end of the shaft S may be manual or automatic and may be connected to any mechanism as long as the shaft can be reciprocated.

As a manual reciprocating mechanism, for example, a toggle mechanism using a linkage, a screw mechanism affording reciprocation in the axial direction by simply screwing a valve disc and the like can be used. As a reciprocating mechanism using a mechanical power, a cylindrical movable shaft operable by pneumatic or oil hydraulics, electromagnetic solenoid and the like can be used.

The material, size, shape of details necessary for open/shut, configurational constitution thereof and the like of the conventionally-known parts such as a housing constitute a valve chest, drive apparatus (for manual screw apparatus, automatic cylinder etc.) for reciprocation of a valve disc, O-ring of each part and the mounting structure thereof, a pipe coupling part with an external pipe arrangement, specification of bellows in the case of a bellows valve and the like, may be known by reference to conventional valve devices and conventional bellows valve devices.

The use of the valve structure and valve device is not particularly limited, and may be a general use for controlling the flow of a fluid such as a gas (air, various gases), a liquid (oil, water, food, medication, mixture, compound) and the like, as well as handling of a high-pressure, high-vacuum, specific fluid.

As discussed in the explanation of the prior art, a piping for exhaustion of a diffusion furnace used for a semiconductor production process and the like is associated with a problem of deposition of reaction products on the valve seat surface and valve disc surface. By the use of the valve as a control valve apparatus of such piping, usefulness of the valve device becomes more remarkable.

### EXAMPLES

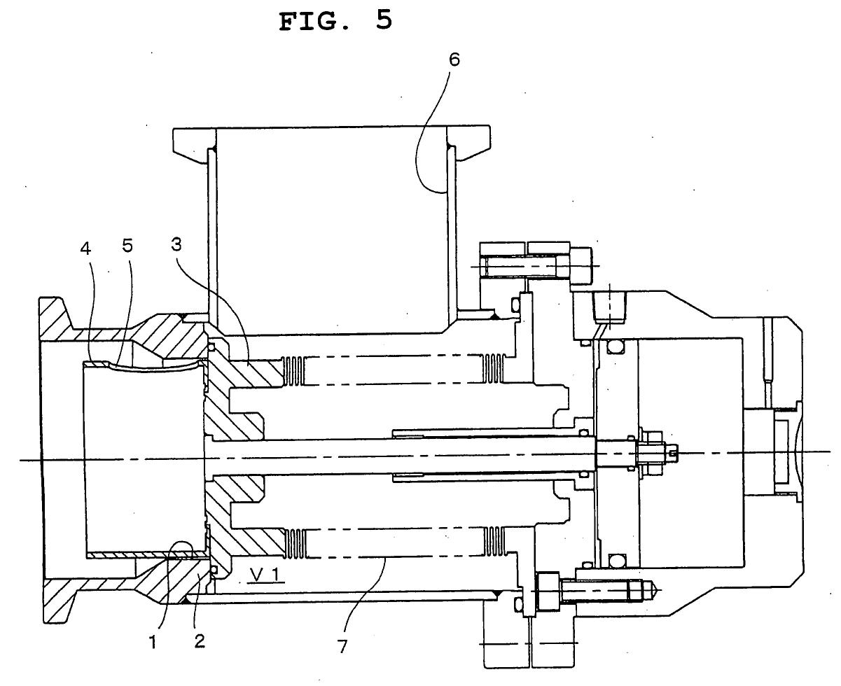

An L type bellows valve having the valve structure of the present invention was actually prepared. A section thereof is shown in FIG. 5.

In FIG. 5, a valve disc 3, a valve seat (integrated with an inlet port) 2, and a tubular part 4 alone are hatched to clarify the area of each part. A middle part of the bellows is omitted from the drawing in FIG. 5. The inlet port and the outlet port open in the inner wall of a valve chest V1 in such a manner that the central axes thereof cross at an angle of 90°.

The inner diameter of the valve hole is 70 mm, and the stroke of the valve disc is 36 mm.

The tubular part is a stainless circular cylinder, having a thickness of 2 mm, an outer diameter of 68.5 mm, and a whole length of 44.5 mm from the valve disc surface. The tubular part was bonded to the valve disc (material SUS304) by TIG (tungsten inert gas) welding.

The through-hole formed in the tubular part had a circular shape of the opening (when seen along the central axis) with an inner diameter of 32 mm, which faced an outlet port (upper side of the drawing).

The distance d1 between the through-hole and the valve seat surface shown in FIG. 3 was 7 mm, and the distance d2 between the through-hole and the valve disc surface shown in FIG. 3 was 3.5 mm.

(Evaluation)

The valve device (L type bellows valve) of the present invention having the above-mentioned constitution was inserted into a piping and used as a control valve of an exhaust gas from a diffusion furnace. Semiconductor wafers were produced repeatedly, and the level of deposition of the contained substances on the valve seat surface was observed.

For comparison, using an L type bellows valve having a conventional valve structure as shown in FIG. 6, a similar observation was performed.

In the production using a conventional L type bellows valve, the number of particles in the vacuum as measured in the upstream (diffusion furnace side) of the valve increased when the number of wafer treatment exceeded 30 batches.

In contrast, in the production using the L type bellows valve of the present invention, the number of particles in the vacuum did not change even when the number of wafer treatment exceeded 100 batches, which indicated that the vacuum in the diffusion furnace was maintained in a preferable clean state. This is considered to be attributable to the suppressed deposition of the reaction product on the open-close surface of the valve structure of the present invention.

Moreover, it has also been found that conventional valve devices require maintenance to compensate for the degraded shut-off performance in normal production of semiconductor wafers, by disassembling the devices substantially every month, whereas the valve device of the present invention obliterates such maintenance for not less than 6 months.

According to the valve structure of the present invention, the deposition of the contained substance on the valve disc surface can be suppressed even in use for controlling a special fluid (that facilitates deposition of the substances contained therein), such as an exhaustion piping of a diffusion furnace and the like.

In addition, such valve structure has enabled provision of a preferable valve device with a reduced burden of maintenance of the valve disc surface and valve seat surface.

This application is based on a patent application No. 2006-15598 filed in Japan, the contents of which are incorporated in full herein by this reference.

1. A valve structure comprising at least a valve hole open in an inner wall surface of a valve chest, a valve seat surrounding the opening, and a valve disc that comes into a close contact with or disengages from the valve seat to open-close said valve hole, wherein
the valve disc surface, which is a plane on the side of the whole surface of the valve disc to be in close contact with the valve seat, has a protruding tubular part capable of slidably fitting inside the valve hole,
when the valve disc is in the closed position, the entire tubular part is within the valve hole, a clearance in the fitting between the tubular part and the valve hole is capable of substantially shutting off the flow of a fluid passing through the valve hole, the tubular part having an opening in a tip end face, the tubular part having a through-hole in the circumferential surface of its body, and the through-hole being formed at such a position that a part or the whole of the through-hole enter the valve chest when the valve disc is in the open position, and
when the valve disc is moved from the closed position to the open position, the through-hole formed in the tubular part enters the valve chest from the inside of the valve hole, thereby communicating the valve hole and the valve chest through the inside of the tubular part.

2. The valve structure of claim 1, wherein the whole length of the tubular part is so determined as to place the tip of the tubular part within the valve hole even when the valve disc is in the open position.

3. The valve structure of claim 1, wherein the position and size of the through-hole are so determined as to place the whole through-hole within the valve chest when the valve disc is in the open position.

4. The valve structure of claim 1, wherein the valve hole has a circular cross sectional shape, and the tubular part as a cylindrical shape.

5. The valve structure of claim 1, further comprising, besides the valve hole, a fluid passage, communicating with the outside, in the inner wall surface of the valve chest,
the central axis of the valve hole being substantially orthogonal to that of the fluid passage,
the number of the through-hole to be formed in the tubular part being one, and
the through-hole facing the side of the fluid passage opening and the central axis of the hole being parallel to that of the fluid passage.

6. A valve device comprising the valve structure of claim 1.

7. The valve device of claim 6, further comprising an operating shaft to open-close the valve disc in the valve structure from the outside of the valve chest, the shaft being inserted from the outside into the valve chest, and the tip of the shaft being connected to the valve disc.

8. The valve device of claim 6, which is a bellows valve wherein the outer circumference of the body of the operating shaft is covered with a bellows.

9. The valve device of claim 6, which is an L type valve, further comprising, besides the valve hole, a fluid passage opening, communicating with the outside, in the inner wall surface of the valve chest, wherein the central axis of the valve hole is substantially orthogonal to that of the fluid passage.

10. The valve device of claim 9, wherein the central axis of the valve hole is substantially orthogonal to that of the fluid passage,
the number of the through-hole to be formed in the tubular part is one, and
the through-hole faces the fluid passage opening and the central axis of the hole is substantially parallel to that of the fluid passage.

11. A valve device comprising the valve structure of claim 2.

12. A valve device comprising the valve structure of claim 3.

13. A valve device comprising the valve structure of claim 4.

14. A valve device comprising the valve structure of claim 5.
